(19) United States
(12) Patent Application Publication
(10) Pub. No.: US 2026/0336673 A1
(43) Pub. Date: Oct. 29, 2026

(54) METHOD, DEVICE AND MEDIUM FOR SWITCHING VIRTUAL MARSHALLING RADIO BLOCK CENTER FOR HEAVY HAUL RAILWAY

(71) Applicant: CASCO SIGNAL LTD., Shanghai (CN)

(72) Inventors: Ming XIA, Shanghai (CN); Jiao LIU, Shanghai (CN); Xiaowei HOU, Shanghai (CN); Hao LAI, Shanghai (CN); Jiao CHEN, Shanghai (CN); Fanyu ZENG, Shanghai (CN); Tianhe WANG, Shanghai (CN)

(73) Assignee: CASCO SIGNAL LTD., Shanghai (CN)

(21) Appl. No.: 19/117,637

(22) PCT Filed: Nov. 17, 2023
(86) PCT No.: PCT/CN2023/132179

§ 371 Date: Apr. 2, 2025

(30) Foreign Application Priority Data
Mar. 7, 2023 (CN) 202310215458.8

(51) Int. Cl. B61L 27/16; B61L 27/70

(52) U.S. Cl. CPC B61L 27/16; B61L 27/70

(57) ABSTRACT

The present disclosure relates to a method, device and medium for switching a virtual marshalling radio block center for a heavy-haul railway, wherein the method designs two modes of virtual marshalling radio block center V-RBC-led authority transfer and on-board-led authority transfer for a non-marshalled train and a marshalled train respectively, and the switching method includes: 1) the non-marshalled train transfers a monitoring right of the non-marshalled train from a V-RBC to an adjacent V-RBC under the V-RBC-led authority transfer mode; 2) the marshalled train and the non-marshalled train transfer the monitoring right of the non-marshalled train from a V-RBC to an adjacent V-RBC under the on-board-led authority transfer mode; and 3) the marshalled train transfers the monitoring right of the non-marshalled train from a V-RBC to an adjacent V-RBC under the V-RBC-led authority transfer mode.

### TECHNICAL FIELD

The present invention relates to a train signal control system, in particular to a method, device and medium for switching a virtual marshalling radio block center for a heavy-haul railway.

### BACKGROUND

Virtual marshalling utilizes wireless communication and automatic control technologies to realize information sharing and coordinate control of two or more trains running adjacent to each other, form a logical community to complete train control and scheduling organization, break through a constraint of an existing block system that a front train is in a stationary state, significantly reduce a tracking distance between trains, and shorten a running interval. It has an advantage of adapting to an unbalanced distribution of freight time and space.

A virtual marshalling radio block center (V-RBC) is a key device to control running of a marshalled train. By controlling each train in the virtual marshalled train to follow a front train closely, stable and cooperative running of the virtual marshalled train is realized, and the aim of safe and efficient running of a train group is finally achieved.

When the heavy-haul line has a large number of jurisdiction stations, it is necessary to set up a plurality of radio block centers for segmented management. Therefore, how to ensure the efficiency of train passage and ensure that the virtual marshalled train can pass through at a high speed has become a technical problem to be solved.

### SUMMARY

The present invention aims to overcome the defects of the prior art and provide a method, device and medium for switching a virtual marshalling radio block center for a heavy-haul railway, so as to ensure that a marshalled train and a non-marshalled train can transfer authority efficiently, shorten a running interval and improve a line transportation capacity.

The purpose of the present invention can be realized by the following technical schemes:

According to a first aspect of the present invention, provided is a method for switching a virtual marshalling radio block center for a heavy-haul railway, wherein the method designs two modes of virtual marshalling radio block center V-RBC-led authority transfer and on-board-led authority transfer for a non-marshalled train and a marshalled train respectively, and the switching method comprises:
1) the non-marshalled train transfers a monitoring right of the non-marshalled train from a V-RBC to an adjacent V-RBC under the V-RBC-led authority transfer mode;
2) the marshalled train and the non-marshalled train transfer the monitoring right of the non-marshalled train from a V-RBC to an adjacent V-RBC under the on-board-led authority transfer mode; and
3) the marshalled train transfers the monitoring right of the non-marshalled train from a V-RBC to an adjacent V-RBC under the V-RBC-led authority transfer mode.

As a preferred technical scheme, the V-RBC-led authority transfer mode is adopted in a long transfer interval with a good communication quality; and the on-board-led authority transfer mode is adopted in a short transfer interval with unstable communication.

As a preferred technical scheme, in the V-RBC-led authority transfer mode, registration of a train and calculation of movement authority are independently managed in a transferring V-RBC and a receiving V-RBC with an execution balise as a boundary.

As a preferred technical scheme, in the on-board-led authority transfer mode, a train establishes communication with both V-RBCs to separately manage marshalling and authority.

As a preferred technical scheme, the process that 1) the non-marshalled train transfers a monitoring right of the non-marshalled train from a V-RBC to an adjacent V-RBC under the V-RBC-led authority transfer mode specifically comprises:
step S101: when movement authority of a communication train extends to a jurisdiction range of a receiving V-RBC, a transferring V-RBC integrates information within the jurisdiction range of the receiving V-RBC in movement authority of a transferring train, and integrated information is transmitted to the train;
step S102: when the transferring V-RBC determines that a location reported by the train is at a location of a pre-notice balise, and the movement authority of the train has crossed a transferring boundary, a distance and an IP address of the receiving V-RBC are transmitted to the train;
step S103: communication is established with the receiving V-RBC, and the train registers with the receiving V-RBC, and transmits parameter information;
step S104: the train runs into the receiving V-RBC, a maximum safety front end of the train leaves the transferring V-RBC, the transferring V-RBC transmits a notification message to the receiving V-RBC, and the receiving V-RBC transmits a take-over message to the transferring V-RBC; and
step S105: a conversation with a previous V-RBC is ended, and a communication session with the transferring V-RBC is ended after a minimum safe rear end of the train leaves the transferring V-RBC.

As a preferred technical scheme, the information within the jurisdiction range of the receiving V-RBC in step S101 comprises a route condition, a track condition and a temporary speed restriction.

As a preferred technical scheme, the process that 2) the marshalled train and the non-marshalled train transfer a monitoring right of the non-marshalled train from a V-RBC to an adjacent V-RBC under the on-board-led authority transfer mode specifically comprises:
step S201: communication is established with the receiving V-RBC, and communication with the receiving V-RBC is established after a fully monitored train runs into a co-management interval;
step S202: movement authority extends to a receiving party; the transferring V-RBC integrates interval train information, hidden train information and marshalling information transmitted by the receiving V-RBC, and calculates extension of the movement authority for the train from a transferring party to the receiving party, reaching up to a home signal ahead where communication with the receiving V-RBC is established; and after the fully monitored train runs into the co-management interval, the communication with the receiving V-RBC is established;
step S203: the receiving V-RBC takes over, and after the train runs into the receiving party, the transferring V-RBC stops calculating the movement authority for the train, which is calculated separately by the receiving party and extends cross the home signal ahead; and
step S204: the communication with the transferring V-RBC is disconnected; and after the train runs into the receiving party, in order to facilitate the transferring party calculating the movement authority for a subsequent train, the communication with the transferring party is not disconnected temporarily and is then disconnected after the train runs into the station.

As a preferred technical scheme, the process that 3) the marshalled train transfers a monitoring right of the non-marshalled train from a V-RBC to an adjacent V-RBC under the V-RBC-led authority transfer mode is specifically as follows:
step S301: when an endpoint of the movement authority of the marshalled train reaches a V-RBC switching boundary, the transferring V-RBC transmits transferring train pre-notice information to the receiving V-RBC and applies for route information; when the transferring V-RBC obtains the route information provided by the receiving V-RBC, the transferring V-RBC transmits the movement authority extending to a receiving V-RBC area to the marshalled train;
step S2: when the marshalled train runs close to the V-RBC switching boundary, the transferring V-RBC transmits a V-RBC switching command to the virtual marshalled train; and if an on-board communication radio is normal, a communication connection is established with the receiving V-RBC;
step S3: when a maximum safety front end of a tail vehicle of the marshalled train crosses a V-RBC switching point, the receiving V-RBC transmits train takeover information to the transferring V-RBC; and if the virtual marshalled train is properly connected to both the transferring V-RBC and the receiving V-RBC, only the movement authority information of the receiving V-RBC is used; and
step S4: when a minimum safety rear end of the tail vehicle of the marshalled train crosses a V-RBC switching balise group, the communication connection between on-board device and the transferring V-RBC is terminated; and if the on-board device is only connected to the transferring V-RBC before transfer, the on-board device restarts the connection with the receiving V-RBC, and complete the train registration and apply for the movement authority.

According to a second aspect of the present invention, provided is an electronic device, comprising a processor and a memory on which a computer program is stored, wherein the processor, when executing the program, implements the above-mentioned method.

According to third aspect of the present invention, provided is a computer-readable storage medium on which a computer program is stored, wherein the program, when executed by a processor, implements the above-mentioned method.

Compared with the prior art, the present invention has the following advantages:
1) The present invention provides a flexible marshalling that adapts to different train types at the same time to improve operation efficiency and flexibility of operation organization. It ensures the efficient authority transfer of the marshalled train and the non-marshalled train, shortening the running interval, and improving the route transportation capacity.
2) Under the scenario of applying the virtual marshalling technology on the heavy-haul railway, the present invention designs two modes of the V-RBC-led authority transfer and the train-led authority transfer for the non-marshalled train and the marshalled train respectively, which can not only meet the transfer of the marshalled train, but also adapt to switch of a control right of the non-marshalled train, and can be selected according to needs of an actual project. For example, the V-RBC-led authority transfer mode may be adopted in a long transfer interval with a good communication quality; and the on-board-led authority transfer mode may be adopted in a short transfer interval with unstable communication.
3) The V-RBC-led authority transfer method of the present invention has a clear space boundary between the transferring V-RBC and the receiving V-RBC, and has a clear interactive process. Registration of the train and calculation of movement authority are independently managed in the transferring V-RBC and the receiving V-RBC with the execution balise as the boundary, cross interference is less, and the method can adapt to a switching process of a train with a single radio station.
4) In the on-board-led authority transfer method of the present invention, the train establishes communication with both V-RBCs to separately manage marshalling and authority without a need of splicing authority. When communication of a departing train fails and recovers, the switching process may be resumed at the same time to ensure the switching efficiency of the train. At the same time, information exchange between the V-RBCs is relatively simple, which greatly reduces a probability of an error. Moreover, there is little difference between the non-marshalled train and the marshalled train, and adaptability is better.

### BRIEF DESCRIPTION OF THE DRAWINGS

FIG. 1 is a schematic diagram of a process of non-marshalled V-RBC-led authority transfer of the present invention;

FIG. 2 is a schematic diagram of a process of non-marshalled train-led authority transfer of the present invention;

FIG. 3 is a schematic diagram of a process of marshalled train V-RBC-led authority transfer of the present invention; and

FIG. 4 is a schematic diagram of a process of a marshalled train V-RBC-led authority transfer of the present invention.

### DETAILED DESCRIPTION OF THE INVENTION

The following is a clear and complete description of technical schemes in embodiments of the present invention in combination with drawings attached to the embodiments of the present invention. Obviously, the embodiments described is a part of the embodiments of the present invention, but not the whole embodiments. Based on the embodiments of the present invention, all other embodiments obtained by an ordinary skilled person in the art without creative labor shall fall within a protection scope of the present invention.

The present invention designs two modes of V-RBC-led authority transfer and train-led authority transfer for a non-marshalled train and a marshalled train respectively, which solves a problem that a V-RBC needs to adapt to switch of a control right of the non-marshalled train in addition to meeting the transfer of the marshalled train. Advantages and disadvantages of the two manners are compared to adapt to needs of different scenarios.

The present invention does not need to add an additional device, and can be realized by relying on a software algorithm, reducing a device investment and a system cost.

The method of the present invention comprises:
1) the non-marshalled train transfers a monitoring right of the non-marshalled train from a V-RBC to an adjacent V-RBC under the V-RBC-led authority transfer mode;
2) the marshalled train and the non-marshalled train transfer the monitoring right of the non-marshalled train from a V-RBC to an adjacent V-RBC under the on-board-led authority transfer mode; and
3) the marshalled train transfers the monitoring right of the non-marshalled train from a V-RBC to an adjacent V-RBC under the V-RBC-led authority transfer mode.

When the non-marshalled train transfers a monitoring right of the non-marshalled train from a V-RBC to an adjacent V-RBC under the V-RBC-led authority transfer mode, the following steps are executed.
Step S101: when movement authority of a communication train extends to a jurisdiction range of a receiving V-RBC, a transferring V-RBC integrates information, such as a route condition, a track condition and a temporary speed restriction, within the jurisdiction range of the receiving V-RBC in movement authority of a transferring train, and integrated information is transmitted to the train.
Step S102: when the transferring V-RBC determines that a location reported by the train is at a location of a pre-notice balise, and the movement authority of the train has crossed a transferring boundary, a distance and an IP address of the receiving V-RBC are transmitted to the train.
Step S103: communication is established with the receiving V-RBC. The train registers with the receiving V-RBC. and transmits parameter information.
Step S104: the train runs into the receiving V-RBC. A maximum safety front end of the train leaves the transferring V-RBC (running into the receiving V-RBC), the transferring V-RBC transmits a notification message to the receiving V-RBC, and the receiving V-RBC transmits a take-over message to the transferring V-RBC.
Step S105: a conversation with a previous V-RBC is ended. A communication session with the transferring V-RBC is ended after a minimum safe rear end of the train leaves the transferring V-RBC.

When the marshalled train and the non-marshalled train transfer the monitoring right of the non-marshalled train from a V-RBC to an adjacent V-RBC under the on-board-led authority transfer mode, the following steps are executed.
Step S201: communication is established with the receiving V-RBC. Communication with the receiving V-RBC is established after a fully monitored train runs into a co-management interval.
Step S202: movement authority extends to a receiving party. The transferring V-RBC integrates interval train information, hidden train information and marshalling information transmitted by the receiving V-RBC, and calculates extension of the movement authority for the train from a transferring party to the receiving party, reaching up to a home signal ahead where communication with the receiving V-RBC is established. The communication with the receiving V-RBC is established after the fully monitored train runs into the co-management interval.
Step S203: the receiving V-RBC takes over. After the train runs into the receiving party, the transferring V-RBC stops calculating the movement authority for the train, which is calculated separately by the receiving party and may extend cross the home signal ahead.
Step S204: the communication with the transferring V-RBC is disconnected. After the train runs into the receiving party, in order to facilitate the transferring party calculating the movement authority for a subsequent train, the communication with the transferring party is not disconnected temporarily and is then disconnected after the train runs into the station.

When the marshalled train transfers the monitoring right of the non-marshalled train from a V-RBC to an adjacent V-RBC under the V-RBC-led authority transfer mode, the following steps are executed.
Step S301: when an endpoint of the movement authority of the marshalled train reaches a V-RBC switching boundary, the transferring V-RBC transmits transferring train pre-notice information to the receiving V-RBC and applies for route information. When the transferring V-RBC obtains the route information provided by the receiving V-RBC, the transferring V-RBC transmits the movement authority extending to a receiving V-RBC area to the marshalled train.
Step S302: when the marshalled train runs close to the V-RBC switching boundary, the transferring V-RBC transmits a V-RBC switching command to the virtual marshalled train. If an on-board communication radio is normal, a communication connection is established with the receiving V-RBC.
Step S303: when a maximum safety front end of a tail vehicle of the marshalled train crosses a V-RBC switching point, the receiving V-RBC transmits train takeover information to the transferring V-RBC. If the virtual marshalled train is properly connected to both the transferring V-RBC and the receiving V-RBC, only the movement authority information of the receiving V-RBC is used.
Step S304: when a minimum safety rear end of the tail vehicle of the marshalled train crosses a V-RBC switching balise group, the communication connection between on-board device and the transferring V-RBC is terminated. If the on-board device is only connected to the transferring V-RBC before transfer, the on-board device restarts the connection with the receiving V-RBC, and complete the train registration and apply for the movement authority.

### SPECIFIC EXAMPLES

The present invention is implemented under different scenarios of applying the virtual marshalling technology on the heavy-haul railway, and designs two modes of the V-RBC-led authority transfer and the train-led authority transfer for an authority transfer process of the non-marshalled train and the marshalled train respectively, so as to adapt to needs of different scenarios.

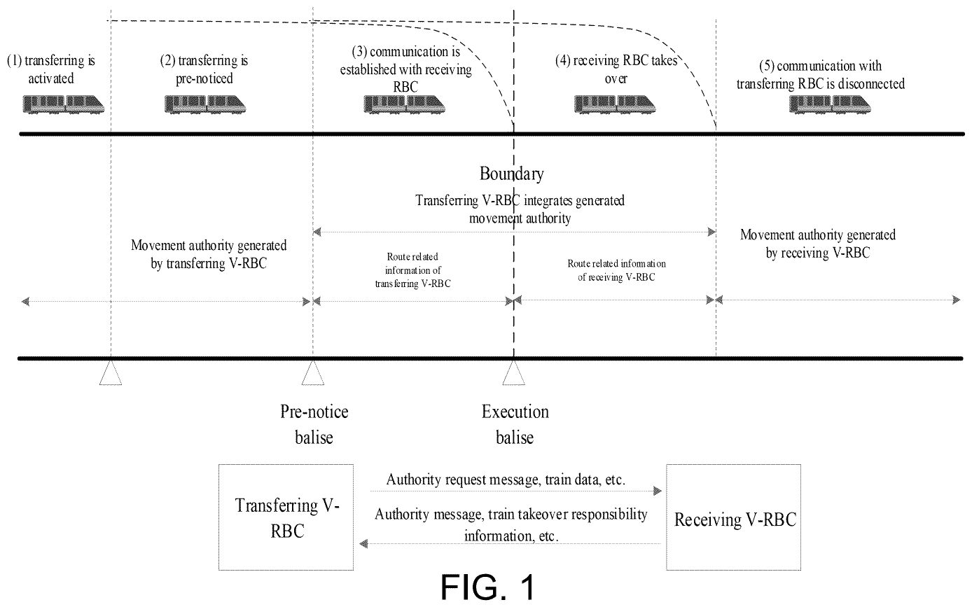

1. The non-marshalled train V-RBC-led authority transfer is as shown in FIG. 1.

There is a train A in a jurisdiction interval of the transferring V-RBC, movement authority of the train A extends to a jurisdiction range of the receiving V-RBC, a transferring process is activated, the transferring V-RBC integrates information, such as a route condition, a track condition and a temporary speed restriction, within the jurisdiction range of the receiving V-RBC in movement authority of a transferring train, and the integrated information is transmitted to the train A.

When the transferring V-RBC determines that a location reported by the train is at a location of a pre-notice balise, and the movement authority of the train A has crossed a transferring execution balise, the transferring V-RBC transmits a distance and an IP address of the receiving V-RBC to the train A.

The train A registers with the receiving V-RBC, and communication is established with the receiving V-RBC.

A maximum safety front end of the train A leaves the transferring V-RBC (running into the receiving V-RBC), the transferring V-RBC transmits a notification message to the receiving V-RBC, and the receiving V-RBC transmits a take-over message to the transferring V-RBC.

A communication session with the transferring V-RBC is ended after a minimum safe rear end of the train A leaves the transferring V-RBC.

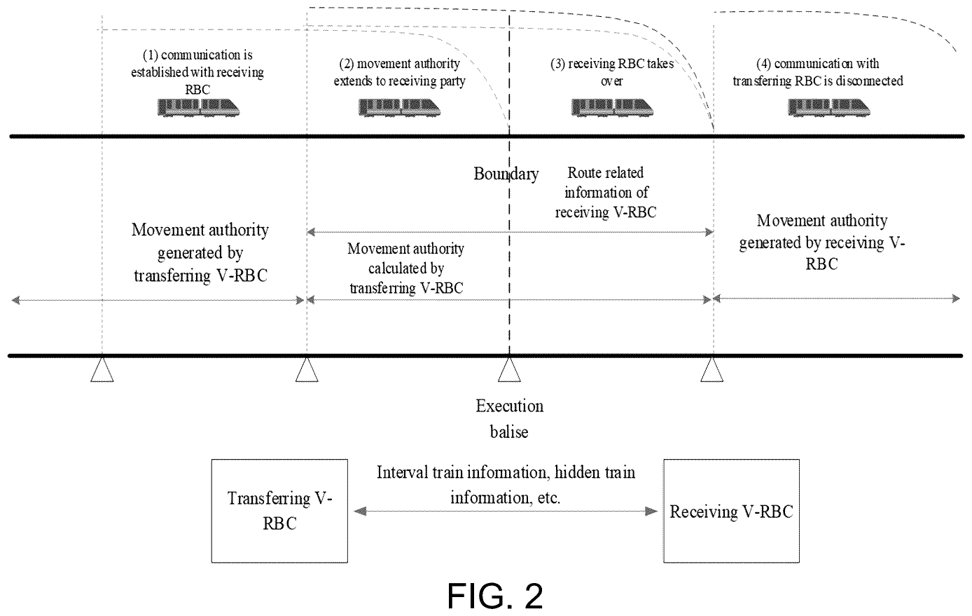

2. The non-marshalled train on-board-led authority transfer is as shown in FIG. 2.

The communication with the receiving V-RBC is established after the fully monitored train A runs into the co-management interval of the transferring V-RBC and the receiving V-RBC.

The transferring V-RBC integrates interval train information, hidden train information and marshalling information transmitted by the receiving V-RBC, and calculates extension of the movement authority for the train A from a transferring party to the receiving party, reaching up to a home signal ahead where communication with the receiving V-RBC is established.

After the train A runs into the receiving V-RBC, the transferring V-RBC may stop calculating the movement authority for the train, which is calculated separately by the receiving V-RBC and extends cross the home signal ahead.

After the train A runs into the receiving V-RBC, in order to facilitate the transferring party calculating the movement authority for a subsequent train, the communication with the transferring party is not disconnected temporarily and is then disconnected after the train A runs into the station.

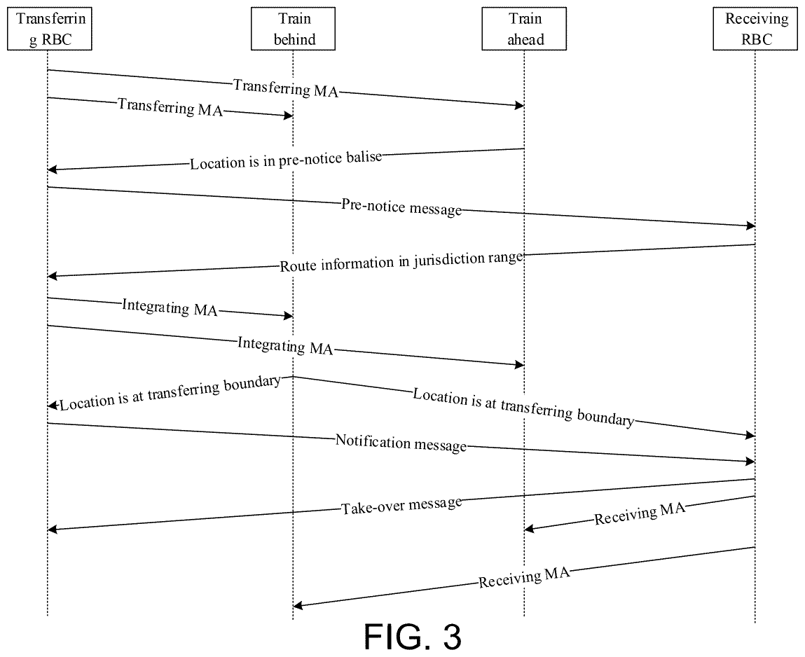

3. The marshalled train V-RBC-led authority transfer is as shown in FIG. 3.

When an endpoint of the movement authority of the marshalled train reaches a V-RBC switching boundary, the transferring V-RBC transmits transferring train pre-notice information to the receiving V-RBC and applies for route information. When the transferring V-RBC obtains the route information provided by the receiving V-RBC, the transferring V-RBC transmits the movement authority extending to a receiving V-RBC area to the marshalled train A.

When the marshalled train runs close to the V-RBC switching boundary, the transferring V-RBC transmits a V-RBC switching command to the virtual marshalled train. If an on-board communication radio is normal, a communication connection is established with the receiving V-RBC.

When a maximum safety front end of a tail vehicle of the marshalled train crosses a V-RBC switching point, the receiving V-RBC transmits train takeover information to the transferring V-RBC. If the virtual marshalled train is properly connected to both the transferring V-RBC and the receiving V-RBC, only the movement authority information of the receiving V-RBC is used.

When a minimum safety rear end of the tail vehicle of the marshalled train crosses a V-RBC switching balise group, the communication connection between on-board device and the transferring V-RBC is terminated. If the on-board device is only connected to the transferring V-RBC before transfer, the on-board device restarts the connection with the receiving V-RBC, and complete the train registration and apply for the movement authority.

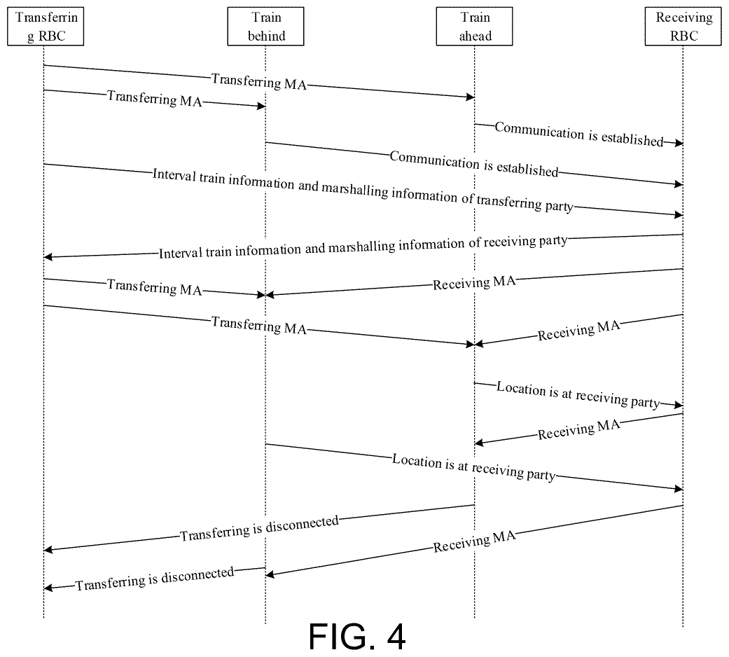

4. The marshalled train on-board-led authority transfer method is as shown in FIG. 4.

After the marshalled train A enters the co-management area, the receiving V-RBC is called and the communication is established. Through interaction of the train information and the hidden train information within the jurisdiction range, the V-RBC calculates the movement authority for the marshalled train A at the same time, and transmits it to the on-board device, which is selected by the on-board to use according to a train location. The movement authority of the transferring party in the co-management area extends only to the home signal ahead.

When a minimum safety rear end of the marshalled train A crosses a V-RBC switching balise group, the transferring party no longer transmits the movement authority to the train. The receiving V-RBC may extend the movement authority according to a state of the road ahead.

The above is an introduction to embodiments of the method, and the schemes of the present invention are further explained by embodiments of an electronic device and a storage medium.

The electronic device of the present invention comprises a central processing unit (CPU) that can perform various appropriate actions and processes according to computer program instructions stored in a read-only memory (ROM) or loaded from a storage unit into a random access memory (RAM). In the RAM, various programs and data required for an operation of the device can also be stored. The CPU, ROM, and RAM are connected to each other via a bus. An input/output (I/O) interface is also connected to the bus.

A plurality of components in the device are connected to the I/O interface, comprising: input units, such as a keyboard and a mouse; output units, such as various types of displays and speakers; storage units, such as a disk and an optical disc; and communication units, such as a network card, a modem and a wireless communication transceiver. The communication unit allows the device to exchange information/data with other devices through a computer network such as the Internet and/or various telecommunications networks.

The processing unit performs each of the methods and processes described above, such as the methods of the present invention. For example, in some embodiments, the methods of the present invention may be realized as a computer software program that is physically contained in a machine-readable medium, such as a storage unit. In some embodiments, parts or all of the computer program may be loaded and/or installed on the device via the ROM and/or the communication unit. When the computer program is loaded into the RAM and executed by the CPU, one or more steps of the above-mentioned methods of the present invention can be performed. Alternatively, in other embodiments, the CPU may be configured to execute the methods of the present invention by any other appropriate manner (e.g., with the help of a firmware).

The functions described above herein can be performed, at least in part, by one or more hardware logical components. For example, without limitation, demonstration types of hardware logic components that can be used comprise: a field programmable gate array (FPGA), an application-specific integrated circuit (ASIC), an application-specific standard product (ASSP), a system-on-chip (SOC), a complex programmable logic device (CPLD), and so on.

The program codes for implementing the method of the present invention may be written in any combination of one or more pieces of programming language. These program codes may be provided to a processor or controller of a general-purpose computer, a special-purpose computer or another programmable data processing device so that the program codes, when executed by the processor or controller, implements the functions/operations specified in the flow chart and/or block diagram. The program codes can be executed entirely on a machine, partially on a machine, partially on a machine and partially on a remote machine or completely on a remote machine or server as a stand-alone software package.

In the context of the present invention, the machine readable medium may be a tangible medium that may contain or store a program for use by or in conjunction with an instruction executing system, apparatus or device. The machine readable medium may be a machine readable signal medium or a machine readable storage medium. The machine readable medium may comprise, but is not limited to, an electronic, magnetic, optical, electromagnetic, infrared, or semiconductor system, apparatus, or device, or any suitable combination of the above. More specific examples of the machine readable storage medium would comprise an electrical connection based on one or more wires, a portable computer disk, a hard disk, a random access memory (RAM), a read-only memory (ROM), an erasable programmable ROM (EPROM or flash memory), an optical fiber, a convenient compact disk ROM (CD-ROM), an optical storage device, a magnetic storage device, or any suitable combination of the above.

The above are only specific embodiments of the present invention, but the protection scope of the present invention is not limited to this, and any technical person familiar with the technical field can easily think of various equivalent modifications or replacements within the technical scope disclosed by the present invention, which shall be covered by the protection scope of the present invention. Therefore, the protection scope of the present invention shall be subject to the protection scope of the claims.

1. A method for switching a virtual marshalling radio block center for a heavy-haul railway, wherein the method designs two modes of virtual marshalling radio block center V-RBC-led authority transfer and on-board-led authority transfer for a non-marshalled train and a marshalled train respectively, and the method for switching comprises:
1) the non-marshalled train transfers a monitoring right of the non-marshalled train from a V-RBC to an adjacent V-RBC under a V-RBC-led authority transfer mode;
2) the marshalled train and the non-marshalled train transfer the monitoring right of the non-marshalled train from a V-RBC to an adjacent V-RBC under an on-board-led authority transfer mode; and
3) the marshalled train transfers the monitoring right of the non-marshalled train from a V-RBC to the adjacent V-RBC under the V-RBC-led authority transfer mode.

2. The method for switching the virtual marshalling radio block center for the heavy-haul railway according to claim 1, wherein the V-RBC-led authority transfer mode is adopted in a long transfer interval with a good communication quality; and the on-board-led authority transfer mode is adopted in a short transfer interval with unstable communication.

3. The method for switching the virtual marshalling radio block center for the heavy-haul railway according to claim 1, wherein in the V-RBC-led authority transfer mode, a registration of a train and calculation of movement authority are independently managed in a transferring V-RBC and a receiving V-RBC with an execution balise as a boundary.

4. The method for switching the virtual marshalling radio block center for the heavy-haul railway according to claim 1, wherein in the on-board-led authority transfer mode, a train establishes communication with both V-RBCs to separately manage marshalling and authority.

5. The method for switching the virtual marshalling radio block center for the heavy-haul railway according to claim 1, wherein a process that 1) the non-marshalled train transfers the monitoring right of the non-marshalled train from a V-RBC to the adjacent V-RBC under the V-RBC-led authority transfer mode specifically comprises:
step S101: when a movement authority of a communication train extends to a jurisdiction range of a receiving V-RBC, a transferring V-RBC integrates information within the jurisdiction range of the receiving V-RBC in a movement authority of a transferring train, and integrated information is transmitted to the train;
step S102: when the transferring V-RBC determines that a location reported by the train is at a location of a pre-notice balise, and a movement authority of the train has crossed a transferring boundary, a distance and an IP address of the receiving V-RBC are transmitted to the train;
step S103: communication is established with the receiving V-RBC, and the train registers with the receiving V-RBC, and transmits parameter information;
step S104: the train runs into the receiving V-RBC, a maximum safety front end of the train leaves the transferring V-RBC, the transferring V-RBC transmits a notification message to the receiving V-RBC, and the receiving V-RBC transmits a take-over message to the transferring V-RBC; and
step S105: a conversation with a previous V-RBC is ended, and a communication session with the transferring V-RBC is ended after a minimum safe rear end of the train leaves the transferring V-RBC.

6. The method for switching the virtual marshalling radio block center for the heavy-haul railway according to claim 5, wherein the information within the jurisdiction range of the receiving V-RBC in step S101 comprises a route condition, a track condition and a temporary speed restriction.

7. The method for switching the virtual marshalling radio block center for the heavy-haul railway according to claim 1, wherein a process that 2) the marshalled train and the non-marshalled train transfer the monitoring right of the non-marshalled train from a V-RBC to the adjacent V-RBC under the on-board-led authority transfer mode specifically comprises:
step S201: communication is established with a receiving V-RBC, and communication with the receiving V-RBC is established after a fully monitored train runs into a co-management interval;
step S202: a movement authority extends to a receiving party; the transferring V-RBC integrates interval train information, hidden train information and marshalling information transmitted by the receiving V-RBC, and calculates extension of the movement authority for the train from a transferring party to the receiving party, reaching up to a home signal ahead where communication with the receiving V-RBC is established; and after the fully monitored train runs into the co-management interval, the communication with the receiving V-RBC is established;
step S203: the receiving V-RBC takes over, and after the train runs into the receiving party, the transferring V-RBC stops calculating the movement authority for the train, which is calculated separately by the receiving party and extends cross the home signal ahead; and
step S204: the communication with the transferring V-RBC is disconnected; and after the train runs into the receiving party, in order to facilitate the transferring party calculating the movement authority for a subsequent train, the communication with the transferring party is not disconnected temporarily and is then disconnected after the train runs into the station.

8. The method for switching the virtual marshalling radio block center for the heavy-haul railway according to claim 1, wherein a process that 3) the marshalled train transfers the monitoring right of the non-marshalled train from a V-RBC to the adjacent V-RBC under the V-RBC-led authority transfer mode is specifically:
step S301: when an endpoint of a movement authority of the marshalled train reaches a V-RBC switching boundary, the transferring V-RBC transmits transferring train pre-notice information to a receiving V-RBC and applies for route information; when the transferring V-RBC obtains the route information provided by the receiving V-RBC, the transferring V-RBC transmits the movement authority extending to a receiving V-RBC area to the marshalled train;
step S2: when the marshalled train runs close to the V-RBC switching boundary, the transferring V-RBC transmits a V-RBC switching command to a virtual marshalled train; and if an on-board communication radio is normal, a communication connection is established with the receiving V-RBC;
step S3: when a maximum safety front end of a tail vehicle of the marshalled train crosses a V-RBC switching point, the receiving V-RBC transmits train takeover information to the transferring V-RBC; and if the virtual marshalled train is properly connected to both the transferring V-RBC and the receiving V-RBC, only a movement authority information of the receiving V-RBC is used; and
step S4: when a minimum safety rear end of the tail vehicle of the marshalled train crosses a V-RBC switching balise group, the communication connection between an on-board device and the transferring V-RBC is terminated; and if the on-board device is only connected to the transferring V-RBC before transfer, the on-board device restarts a connection with the receiving V-RBC, and complete a train registration and apply for the movement authority.

9. An electronic device, comprising a processor and a memory on which a computer program is stored, wherein the processor, when executing the program, implements the method according to claim 1.

10. An non-transitory computer-readable storage medium on which a computer program is stored, wherein the program, when executed by a processor, implements the method according to claim 1.

11. An electronic device, comprising a processor and a memory on which a computer program is stored, wherein the processor, when executing the program, implements the method according to claim 2.

12. An electronic device, comprising a processor and a memory on which a computer program is stored, wherein the processor, when executing the program, implements the method according to claim 3.

13. An electronic device, comprising a processor and a memory on which a computer program is stored, wherein the processor, when executing the program, implements the method according to claim 4.

14. An electronic device, comprising a processor and a memory on which a computer program is stored, wherein the processor, when executing the program, implements the method according to claim 5.

15. An electronic device, comprising a processor and a memory on which a computer program is stored, wherein the processor, when executing the program, implements the method according to claim 6.

16. An electronic device, comprising a processor and a memory on which a computer program is stored, wherein the processor, when executing the program, implements the method according to claim 7.

17. An electronic device, comprising a processor and a memory on which a computer program is stored, wherein the processor, when executing the program, implements the method according to claim 8.
